(19) United States
(12) Patent Application Publication
(10) Pub. No.: US 2002/0184369 A1
(43) Pub. Date: Dec. 5, 2002

(54) Appointment scheme for redistributing service access

(76) Inventor: Steven William Parkinson, San Francisco, CA (US)

Correspondence Address: FINNEGAN, HENDERSON, FARABOW, GARRETT &, DUNNER LLP, 1300 I STREET, NW, WASHINGTON, DC, 20006, US

(21) Appl. No.: 09/867,647

(22) Filed: May 31, 2001

(51) Int. Cl. G06F 15/173; G06F 15/16

(52) U.S. Cl. 709/226; 709/219

(57) ABSTRACT

A process is provided for regulating server request loads by use of a scheduling technique in a system having a client application and a server application. The process involves the server application receiving a request for service from a client application, determining a quality of service for each request, and returning an appointment to the client application reflecting a time at or after which the server application will be able to process the request.

### DESCRIPTION OF THE INVENTION

1. Technical Field

This invention relates generally to methods and systems for scheduling service in a client-server environment. More particularly, this invention relates to methods and systems for scheduling service by a server application.

2. Description of Related Art

The Internet, fueled by the phenomenal popularity of the World Wide Web (WWW or the “web”), has exhibited exponential growth over the past few years. In the case of the WWW, the ease of self-publication has helped generate an estimated 50-120 million documents on a broad range of subjects.

To access all this information, users need only standard computer equipment, such as a personal computer with a display and modem, and an Internet connection. Several types of Internet connections are available, including connections through Internet Service Providers (ISPs). To use an Internet connection from an ISP, for example, the user causes the personal computer to connect electronically to a computer at the ISP's facility using the modem and a standard telephone line. The ISP's computer in turn provides the user with access to the Internet.

The user's computer is typically referred to as a “client,” whereas the computer to which the client connects for a service, such as access to information, is typically called a “server.” This naming convention was adopted because of their respective roles of processes operative on each computer: clients utilize services of servers.

Through the Internet connection, the user accesses information on the web using a computer program called a “web browser,” such as the Netscape Navigator™ from Netscape Communications Corporation. To accomplish this, the user inputs to the web browser a Uniform Resource Locator (URL) identifying an object on the Internet, for example, a document containing information of interest. The web browser retrieves the web page and displays it for the user.

The document is referred to as a “web page,” and the information contained in the web page is called “content.” Web pages often refer to other web pages using “hypertext link” or “hyperlinks” that include words or phrases representing the other pages in a form that gives the browser a URL for the corresponding web page when a user selects a hyperlink. Hyperlinks are made possible by building web pages using the Hypertext Markup Language (HTML).

The URL identifies a specific “server” computer on the Internet and, more particularly, the location of a web page located on the server. A process called a “web server” runs on the server and handles this type of request from a web browser.

The Internet thus provides users access to a wide variety of information. For example, users can use the Internet to locate information on current and upcoming events in cities and communities throughout the world.

Web servers and other processes that handle client requests for example, require significant server resources. For example, each request typically requires a response and the server requires processing cycles to build and transmit a response. Some responses may even require the server to invoke one or more processes, each providing a component of the response. In one example, the request may seek information from a database accessible by the server. In this case the server may invoke a process to communicate with another computer connected that houses the database. That database computer may also have a separate process that handles database access and retrieval.

Often servers can provide responses in a matter of seconds or less. But as load on a server increases the response time typically gets longer and longer and access is often arbitrarily determined. Response to requests depends not just on when a request is made, but also if a request was recently completed. Additionally, when requests require a server to invoke one or more processes response time increases. At some point the response time may reach an unacceptable level. Moreover, increased server load of this type can cause server failures, which is also unacceptable.

### SUMMARY OF THE INVENTION

In accordance with the present invention, server request load is regulated by a scheduling technique. In accordance with one aspect of the present invention, as embodied and broadly described herein, a method is performed by a server for managing system load. The server receives requests for services from clients. The server determines, for each request, a quality of service reflecting an ability of the server to respond within a predetermined time based on a type associated with the request. Based on a result of this determination, the server may return to a client an appointment reflecting a time for the client to resend the request (or send another request) to the server for processing.

In accordance with another aspect of the present invention, as embodied and broadly described herein, a method is performed by a client in connection with managing system load on a server. The client transmits a request for service to the server. Based on a result of a determination by the server concerning the server's ability to process the request, the client receives from the server an appointment reflecting a time at which the server will be available to process the request. The client resubmits the request (or sends another request) to the server at or after the appointment time.

In accordance with the present invention, as embodied and broadly described herein, a system comprises a server, a client, a network connecting the server to the client. The server receives requests from the client. The server identifies a process capable of generating a response to the request. The server determines whether the identified process is able to generate the response subject to a predetermined level of quality. The server creates an appointment reflecting a time at which it is determined that the identified process will be able to generate the response subject to the predetermined level of quality and provides the appointment to the client.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate an embodiment of the invention and, together with the description, serve to explain the advantages and principles of the invention. In the drawings,

FIG. 1 shows a client/server system in which embodiments of the present invention may be implemented;

FIG. 2 shows a more detailed view of the client/server system illustrated in FIG. 1;

FIG. 3 shows that structure of a workstation in which a client process or a server process may be operative;

FIG. 4 show a flow diagram of the scheduling technique for regulation of server request load;

FIG. 5 shows a flow diagram of the client requesting service;

FIG. 6 show a flow diagram of the client receiving a response to a request for service;

FIG. 7 shows a block diagram of modules of the appointment cookie.

### DETAILED DESCRIPTION

Reference will now be made in detail to an implementation of the present invention as illustrated in the accompanying drawings. Wherever possible, the same reference numbers will be used throughout the drawings and the following description to refer to the same or like parts.

The present invention may be implemented by computers organized in a conventional distributed processing system architecture. The architecture for and procedures to implement this invention, however, are not conventional, because they provide a mechanism for scheduling operations of a server to overcome the shortcomings of the related art.

A. Overview

Systems and methods consistent with the present invention use a scheduling technique to provide an improved quality of service for software applications. In accordance with the principles of the present invention, a first application sends a request for service to a second application. Typically the applications are located on separate computers connected by a network, although the applications may reside on the same machine in certain implementations of the present invention.

Upon receipt of the request, the second application determines a quality of service for processing the request. Certain requests may require more resources than others. Depending on the type of request from the first application as well as the number and/or types of requests pending at the time of receipt of the request from the first application, the second application may determine that the quality of service for processing the request from the first application is below an acceptable level. In one configuration, the second application determines whether it can process the request to provide a result within an acceptable time period, which may be ascertained from the type of request.

If the determination results in a conclusion that the threshold quality of service may not be met for a particular request, the second application returns an appointment to the first application. The appointment specifies a time at or after which the first application can send a new request and represents the position of the request in a queue for service. The first application may be configured to store appointments. Also, the second application may track appointments in a queue.

In certain configurations, the first application may display a notification corresponding to a received appointment. The notification may be generated by the first application or received with the appointment from the second application.

When the second application receives a request that reflects an appointment, the second application determines whether the request was received at or after the time of the appointment. If so, the second application processes the request and returns any requested result. On the other hand, if the request was sent premature, i.e., before the appointment time, the second application returns the same or a new appointment to the first application.

Appointments may be processed in order based on the queue. In this way, the second application may process requests in the order in which they are received or it may process requests in a different order; the order being reflected by the queue.

The first application may be configured to automatically send any stored appointments or indications of appointments with requests. This way when a user operating the first application causes the first application to communicate with the second application for which the first application holds an appointment, the first application will send the appointment or an indication of the appointment to the second application as part of the communication. In other configurations, the first application may automatically and without prompting by the user send a new request with the appointment or an indication of the appointment to the second application at or following the time specified by an appointment. The first application may be further configured to enable users to view pending appointments.

In one implementation consistent with the present invention, the first application may be a browser such as Navigator from Netscape Corp., and the second application may be a web server such as the iPlanet Application Server from the Sun-Netscape Alliance. In this configuration, a user operating the browser enters a uniform resource locator (URL) designating a particular web site.

Using HTTP and associated processes, or another protocol, the web server receives requests from browsers. Each request identifies a particular service. Upon receipt of a request, the web server determines whether an acceptable quality of service may be achieved in providing a response.

For classes of requests that the web server determines it cannot provide an acceptable quality of service immediately upon receipt, the web server generates an appointment, which may be a “cookie.” A cookie is a datum. It represents certain information; in this case information on a time that the web server has reserved for processing a particular request.

Using processing techniques already available in the aforementioned browsers, at a subsequent time when the user enters a URL of a website for which the browser holds an appointment, the browser sends the stored appointment cookie with the URL to the website. Upon receipt of a request with an appointment cookie, the web server determines whether the request was received at or following the time indicated by the appointment cookie. If so, it processes the request and provides a response. Otherwise, the web server returns a notification to the browser indicating that the request was sent before the appointed time.

B. Exemplary System Architecture

Systems and methods consistent with the present invention use a scheduling technique to provide an improved quality of service for software applications. Although the following will be described with reference to particular embodiments, including data structures, flow of steps, hardware configurations, etc., it will be apparent to one skilled in the art that implementations of the present invention can be practiced without these specific details.

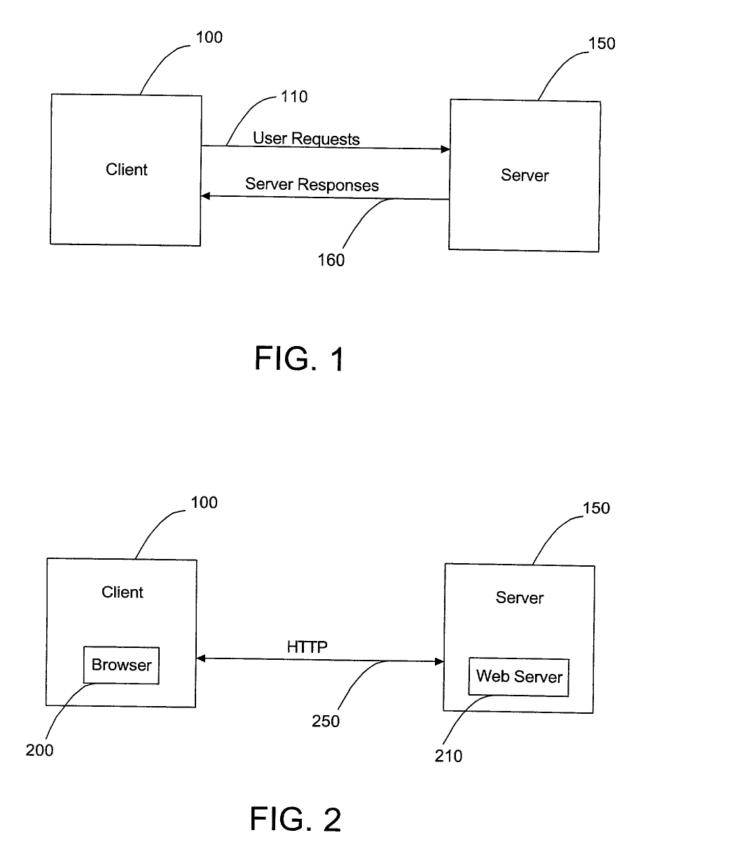

Implementations of the present invention use a client/server architecture, as illustrated in FIG. 1, wherein a client 100 sends user requests 110 for services to a server 150. The server 150, as will be described in more detail below, performs operations based on these user requests 110, and provides information as server responses 160 to the client 100. The client 100 represents a process active in a first computer system, and the server 150 represents a process active in a second computer system. Client 100 and server 150 communicate with one another over a communication medium, such as a network (for example, the Internet), thus providing distributed functionality and allowing multiple clients to take advantage of the server 150. Each process is typically implemented in a computer program.

A more detailed view of the client 100 and server 150 are shown in FIG. 2. Client 100 and server 150 communicate using the functionality provided by Hypertext Transfer Protocol (HTTP). The web includes all the servers adhering to this standard which are accessible to clients via URL's. For example, communication can be provided over a communication medium 250. In some embodiments, the client 100 and server 150 may be coupled via TCP/IP connections for high-capacity communication. Active within the client is a first process, known as a “browser” 200, which establishes the connection with server process 150, and presents information to the user. Any number of commercially or publicly-available browsers may be used, in various implementations, however in this implementation, browser 200 is the Netscape Navigator brand browser available from the Netscape Corp. Other browsers such as the Internet Explorer brand browser from Microsoft Corp., or others which are available and provide the functionality specified under HTTP and the Navigator browser may be used.

The server 150 executes the corresponding server software, called a “web server” 210, which presents information to the browser 200 in the form of HTTP responses. The HTTP responses correspond with the web pages represented using Hypertext Markup Language (HTML), or other data which is generated by the server. In addition to HTML functionality provided by the web server 210 (display and retrieval of certain textual and other data based upon hypertext views and selection of item(s)), a Common Gateway Interface (CGI) may be provided to allow the browser 200 to direct the web server 210 to commence execution of a specified program contained within or associated with the server 150. This may include a search engine which scans received information in the server for presentation to the user controlling the client. Using this interface, and HTTP, the server may notify the client of the results of that execution upon completion. In order to control the parameters of the execution of this server-resident process, the client may direct the filling out of certain “forms” from the browser 200. This is also provided by a “fill-in forms” functionality associated with the web server 210, which allows the user via the browser 200, to specify search terms in which the server will cause an application program to function (e.g. terms contained in the types of stories/articles which are of interest to the user).

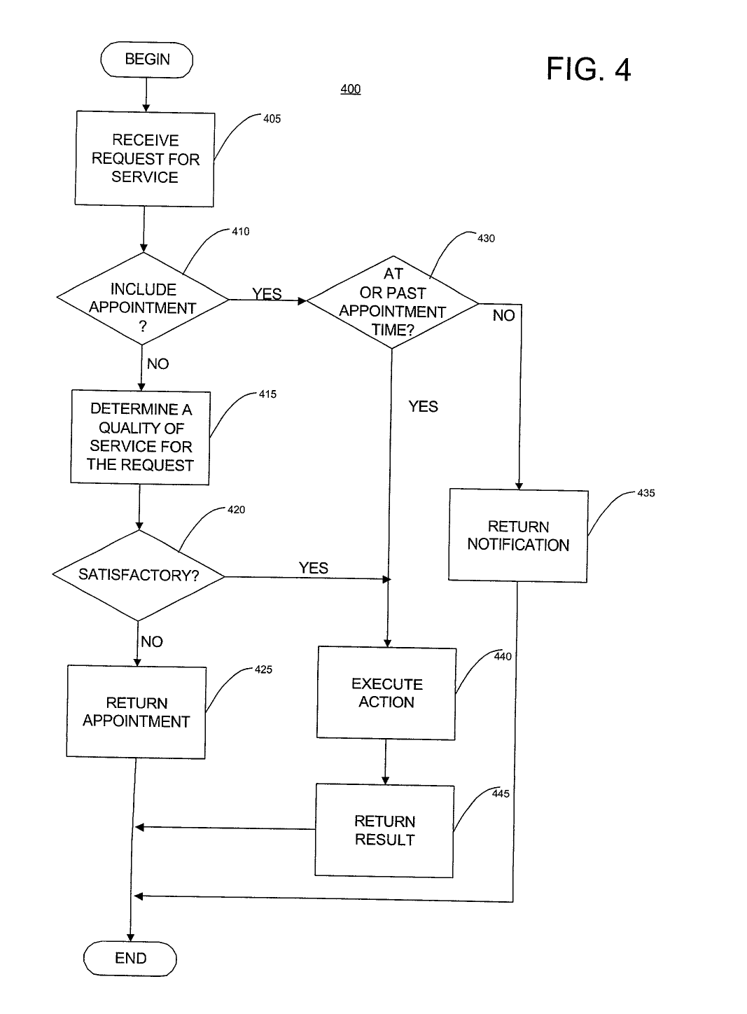

In one configuration consistent with the present invention browser 200 handles appointments as cookies using conventional techniques (described below). The conventional web server 210, however, requires modification to generate and transmit appointment cookies. The required modification to the web server is described below with reference to FIG. 4.

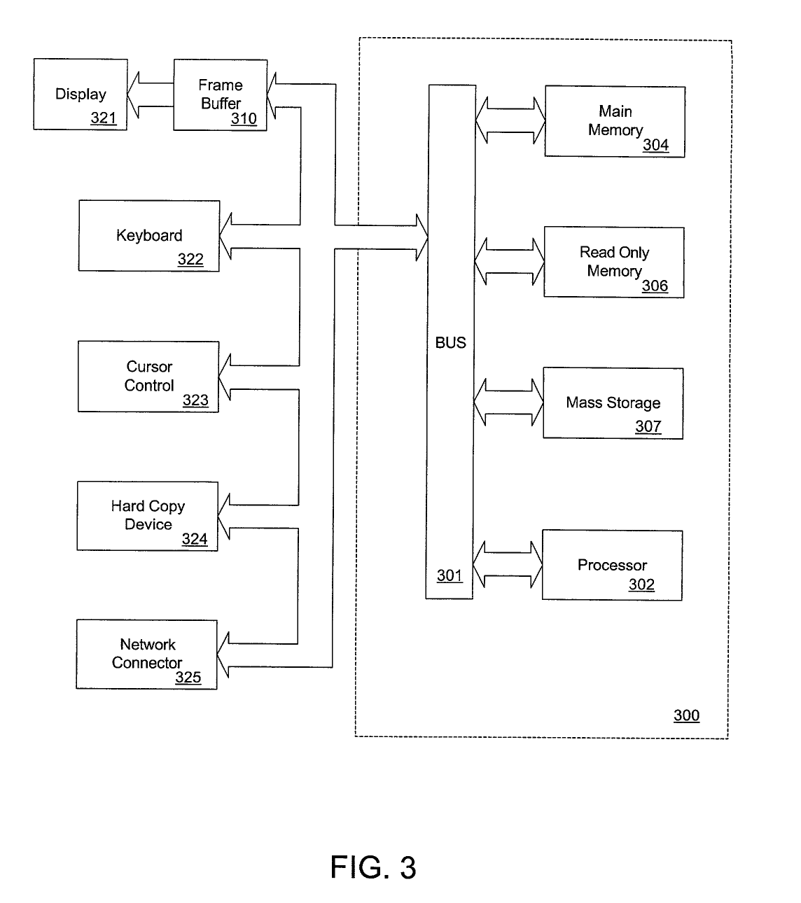

A computer system, such as a workstation, personal computer or other processing apparatus in which the client 100 or server 150 may be operative is illustrated in FIG. 3. A workstation in which one implementation of the present invention may be practiced includes system 300. System 300 comprises a bus or other communication means 301 for communicating information, and a processing means 302 coupled with bus 301 for processing information. System 300 further comprises a random access memory (RAM) or other volatile storage device 304 (referred to as main memory), coupled to bus 301 for storing information and instructions to be executed by processor 302. Main memory 304 also may be used for storing temporary variables or other intermediate information during execution of instructions by processor 302. System 300 also comprises a read only memory (ROM) and/or other static storage device 306 coupled to bus 301 for storing static information and instructions for processor 302, and a data storage device 307 such as a magnetic disk or optical disk and its corresponding disk drive. Data storage device 307 is coupled to bus 301 for storing information and instructions. System 300 may further be coupled to a display device 321, such as a cathode ray tube (CRT) or liquid crystal display (LCD) coupled to bus 301 for displaying information to a computer user. Such a display 321 may further be coupled to bus 301 via a frame buffer 310, which information such as a single or multiple frames or images for display upon display device 321. An alphanumeric input device 322, including alphanumeric and other keys, may also be coupled to bus 301 for communicating information and command selections to processor 302. An additional user input device is cursor control 323, such as a mouse, a trackball, stylus, or cursor direction keys, coupled to bus 301 for communicating direction information and command selections to processor 302, and for controlling cursor movement on display 321.

Note, also, that any or all of the components of system 300 and associated hardware may be used in various embodiments, however, it can be appreciated that any configuration of the system may be used for various purposes according to the particular implementation. In one embodiment, for example, system 300 is one of the Sun Microsystems brand family of workstations, such as the SPARCstation brand workstation manufactured by Sun Microsystems, Inc. of Palo Alto, Calif. Processor 302 may be one of the SPAR™ brand microprocessors manufactured by Sun Microsystems, Inc. of Palo Alto, Calif.

Note that the following discussion of various embodiments discussed herein will refer specifically to a series of routines which are generated in a high-level programming language (e.g., Java™, C++, C and the PERL interpretive language), which is interpreted and/or executed in system 300. It can be appreciated by one skilled in the art, however, that the following methods and apparatus may be implemented in special purpose hardware devices, such as discrete logic devices, large scale integrated circuits (LSI's), application-specific integrated circuits (ASIC's), or other specialized hardware. The description here has equal application to apparatus having similar function.

C. Server Procedure

The procedure 400 that the server uses to manage service requests is illustrated by the flow diagram in FIG. 4. Each request identifies a particular type of service. The request may be for a static web page or a dynamic web page. Static pages are stored pages of information whereas dynamic pages are specifically built by a process in response to the request. Responses that contain static pages may be provided without regard to the amount of time it may take for the web server to locate a page in memory or the amount of time it may take for the web server to send the page in response to a request. Responses that contain dynamic web pages, however, may require significant processing by the web server or associated services, such as database applications, or enrollment or registration applications.

The web server receives requests from browsers (step 405). The server determines whether the request includes an appointment (step 410). If no appointment exists, upon receipt of a request, the web server determines whether an acceptable quality of service may be achieved in providing a response (step 415). The quality of service may include, for example, the time it takes to respond to a request or the processing complexity of the request. It may also include the reliability of processing the request, such as average processing time of similar requests. Other examples include the associated costs of processing the request, such as when more users are serviced simultaneously, more bandwidth is used, which leads to more cost. To determine quality of service, the web server may store a value for each type of request received and use this stored information to determine the quality of service for specific types or classes of requests. When the web server receives a new request it determines the request type, determines the quality of service for the request based on information related to other pending requests, and compares this request with the average quality of service for this request type to determine whether the web server can provide satisfactory service. The web server checks to see if the quality of service is satisfactory (step 420). Satisfactory service can be the ability to respond within an acceptable time period or without errors. If the quality of service is satisfactory, the service request is executed (step 440) and a result is returned (step 445).

If the quality of service is not satisfactory, the web server generates and returns an appointment (step 425). For example, a request that the web server determines it cannot provide an acceptable quality of service immediately upon receipt, the web server generates a “cookie” reflecting an appointment. Additional information regarding cookies can be found in U.S. Pat. No. 5,774,670 to Lou Montulli, which is herein incorporated by reference.

In setting an appointment and prioritizing processing, the web server may consider other information, such as the number of appointment cookies issued instead of immediate responses provided in response to requests from a particular user, the total number of unused appointments, and the number of unused appointments provided in response to requests from a particular user.

Upon receipt of a request with an appointment cookie, the web server determines whether the request was received at or following the time indicated by the appointment cookie (step 430). If received at or following the appointment time, the request is processed (step 440) and a response is provided (step 445). Otherwise, the web server returns a notification to the browser indicating that the request was sent before the appointed time (step 435). The notification may contain the same appointment cookie returned in response to the first request or a new appointment cookie.

Several advantages are realized in responding in such a manner. If the host experiences excessive use, the appointment cookie can be set at a later time, when usage of the resources at server has been reduced. The server may also determine whether the number of requests per unit of time exceeds a predetermined threshold. This threshold may be set by an administrator to protect against server failure.

D. Client Procedure

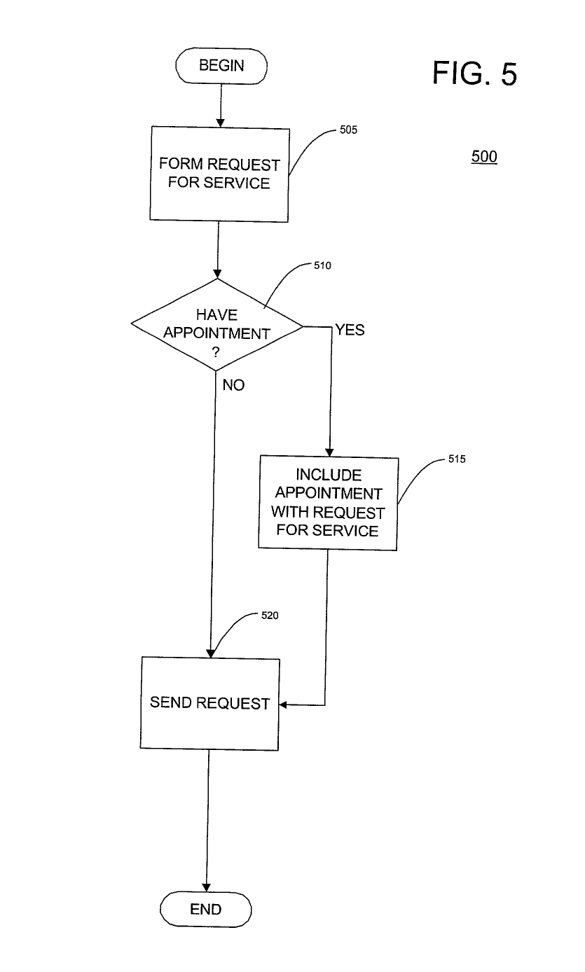

FIG. 5 is a flow diagram of the procedure 500 the client uses to send a request for service. The client first forms a request for service (step 505). Each request identifies a particular service, for example, the request may seek a static or a dynamic web page. A check is performed to see if an appointment for service already exists (step 510). Using processing techniques already available in the aforementioned browsers, at a subsequent time when the user enters a URL of a website for which the browser holds an appointment, the browser sends the stored appointment cookie with the URL to the website (step 515). The request, along with the appointment cookie is sent to the server (flow 520).

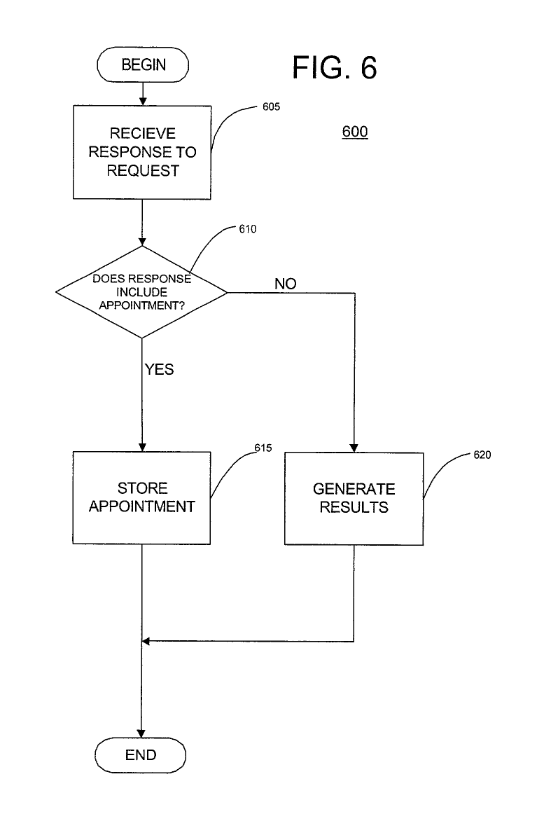

FIG. 6 is a flow diagram of the procedure 600 the client uses to receive a response to a request. When the client receives a response to a request (step 605), the client will check if the response includes an appointment (step 610). If the response includes an appointment, then the appointment is stored (step 615). The browser stores the appointment in the form of a cookie as or in a file. The browser also notifies the user of receipt of an appointment cookie. The notification may be generated by the browser upon receipt of an appointment cookie or it may be received from the web server along with the appointment cookie. If the response does not include an appointment, the browser displays the response in a normal fashion (step 620).

In an alternative embodiment, the browser may provide additional functionality to enable users to view appointments reflected by appointment cookies. For example, encrypted appointment cookies may be restricted from viewing whereas appointment cookies that have digital signatures may be viewed.

Additionally, the browser may be further modified to handle appointments without requiring a user to resubmit requests at or after the time specified in the appointment cookies. In this configuration the browser has a process that monitors pending appointment cookies and automatically resubmits requests to appropriate servers at or after the time specified in the appointment cookies.

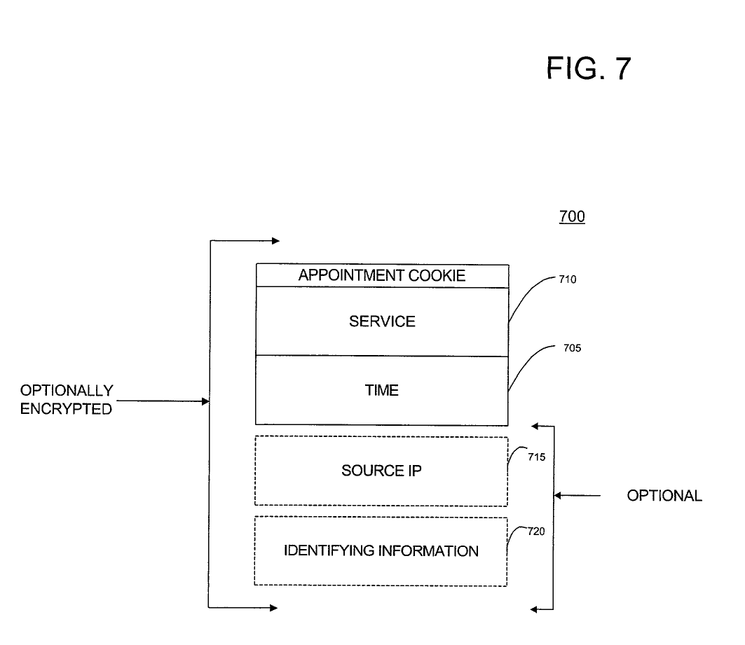

FIG. 7 is a block diagram of the modules of an appointment 700 according to one implementation of the present invention. Appointment component 700 can be a “cookie”, which is a set of data stored in memory that contains certain information. This “cookie” is automatically sent to the server when a browser visits a particular server. The appointment cookie includes the request for which the web server has scheduled an appointment for processing 710 and an appointment time 705. The appointment cookie may also include other information identifying the source of the request 720, such as an IP address 715, to ensure users cannot manipulate the web server by trading appointments. The appointment cookie may also be encrypted using known asymmetric or symmetric encryption methods. By encrypting the appointment cookie, the web server can be certain that users are not manipulating the appointment scheme by creating their own appointments.

Encrypted appointment cookies may not be viewed but appointment cookies that have digital signatures using known signing techniques may be viewed and still provide adequate assurance that users cannot manipulate the system.

E. Conclusion

In accordance with the present invention server processes can better manage limited resources by scheduling appointments to process requests. Based for example on an anticipated quality of service if a request is processed immediately upon receipt, as well as perhaps the effect this immediate processing of a request may have on processing other pending requests, a server process determines a subsequent time for the requester to resubmit the request. When the requester resubmits the request, the server process determines whether the request was made after the appointed time for resubmission and, if so, processes the request immediately. If not, the server process notifies the requester that the request was resubmitted prematurely. Scheduling appointments for handling computationally intensive requests improves server load problems, including minimizing potential overloads that could disrupt service.

As explained, a server process implemented in accordance with the present invention may queue appointments. Queuing appointments tends to reduce the “pot-luck” nature associated with accessing servers; it provides clients with a sense of assurance that their requests will be responded to at designated times.

While specific implementations have been described herein for purposes of illustration, various modifications may be made without departing from the spirit and scope of the invention. For example, clients may specify an acceptable quality of service for their requests. The server may use the client-specified quality of service when determining whether to respond with an appointment.

Those skilled in the art understand that the present invention can be implemented in a wide variety of software platforms. Furthermore, although aspects of the present invention are described as being stored in memory and other storage media, one skilled in the art will appreciate that these aspects can also be stored on or read from other types of computer-readable media, such as secondary storage devices, like hard disks, floppy disks, or CD-ROM; a carrier wave from the Internet; or other forms of RAM or ROM. Substantially similar implementations consistent with the present invention can be created except that the various software and hardware subsystems are contained in a single computer and not distributed over a network as described and illustrated above. Accordingly, the invention is not limited to the above described implementations, but instead is defined by the appended claims in light of their full scope of equivalents.

What is claimed is:

1. In a system comprised of a plurality of client devices, each operating a browser application, and a host device operating a server application, a method for managing service by the server application, comprising:
receiving, by the server application from the browser applications, requests for services;
determining for each request a quality of service reflecting an ability of the server application to respond within a predetermined time based on a type associated with the request; and
returning, by the server application to at least one browser application, an appointment reflecting a time for the browser application to send another request to the server application for processing.

2. A load managing method comprising:
receiving by a server a request for service from a browser;
determining a quality of service for the request, the quality of service reflecting an ability of the server to respond to the request based on a type associated with the request; and
providing an appointment cookie to the browser reflecting a time at or after which the server will be available to process the request.

3. A load managing method comprising:
receiving by a server a request for service from a client;
determining a quality of service for the request, the quality of service reflecting an ability of the server to respond to the request based on a type associated with the request; and
providing an appointment to the client reflecting a time at or after which the server will be available to process the request.

4. A method of claim 3 wherein said type associated with a request is compared to prior requests of said type.

5. In a system having a client and a server, a load managing method comprising the steps, performed by the client, of:
transmitting a request for service to a server; and
receiving from the server an appointment cookie reflecting a time at which the server will be available to process the request.

6. The method of claim 5, further comprising:
enabling display of the appointment cookie.

7. The method of claim 5, further comprising:
re-transmitting the request to the server at or after the time reflected by the appointment cookie.

8. The method of claim 5, further comprising:
automatically without user intervention re-transmitting the request to the server at or after the time reflected by the appointment cookie.

9. In a system having a client and a server, a load managing method comprising the steps, performed by the client, of:
transmitting a request for service to a server; and
receiving from the server an appointment reflecting a time at which the server will be available to process the request.

10. In a system having a client and a server, a load managing method comprising the steps, performed by the client, of:
transmitting a request for service to a server;
receiving from the server an appointment reflecting a time at which the server will be available to process the request; and
resubmitting the request to the server application.

11. In a system having a client and a server, a load managing method comprising the steps, performed by the server, of:
receiving a request for service from the client;
determining a quality of service associated with providing the client with a response to the request; and
providing the client with an appointment reflecting a time at which the server will be available to process the request based on a result of the determination.

12. In a system having a client and a server, a load managing method comprising the steps, performed by the server, of:
receiving a request for service from the client;
determining a quality of service associated with providing the client with a response to the request; and
providing the client with an appointment cookie reflecting a time at which the server will be available to process the request based on a result of the determination.

13. A method for managing load on a process operating in a server computer, comprising:
receiving a request for a service to be performed by the process;
determining whether the process is able to perform the requested service subject to a predetermined level of quality; and
creating an appointment indicating that the process is not able to perform the requested service subject to a predetermined level of quality and reflecting a time at which it is determined that the process will be able to perform the requested service subject to a predetermined level of quality.

14. The method of claim 13, wherein the predetermined level of quality represents a time factor.

15. In a system comprising a first computer and a second computer, a method for managing service by a second computer, the method comprising:
receiving, from the first computer, a request for service;
determining for the request an estimated quality of service reflecting when the second computer will be able to respond to the request; and
if the estimated quality of service is not satisfactory, returning, to the first computer, an appointment,
whereby the second computer will respond to the request for service at or after a time specified by the appointment.

16. In a system comprising a first computer and a second computer, a method for managing requests by a first computer, the method comprising:
transmitting, to the second computer, a request for service;
receiving an appointment, reflecting an estimated time when the second computer will be able to respond to the request; and
resubmitting the request to the second computer on or after the time indicated in the appointment.

17. A system comprising:
a server;
a client;
a network connecting the server to the client; and
said server
(i) receiving a request from said client,
(ii) identifying a process capable of generating a response to the request,
(iii) determining whether the identified process is able to generate the response subject to a predetermined level of quality,
(iv) creating an appointment reflecting a time at which it is determined that the identified process will be able to generate the response subject to the predetermined level of quality, and
(v) providing the appointment to the client.

18. The system of claim 17, wherein said client
(i) receives the appointment from said server,
(ii) determines based on the appointment when to send to said server a new request based on the request, and
(iii) sends the new request to said server based on a result of the determination.

19. The system of claim 18, wherein said client
(iv) includes in the new request information reflecting the appointment.

20. The system of claim 18, wherein said client
(i) receives the appointment from said server,
(ii) includes in the new request information reflecting the appointment.

21. A computer program product capable of configuring a data processor to manage service for a server application, the computer program product comprising program code to cause the data processor to perform the steps of:
receiving, by the server application from browser applications, requests for services;
determining for each request a quality of service reflecting an ability of the server application to respond within a predetermined time based on a type associated with the request; and
returning, by the server application to at least one browser application, an appointment reflecting a time for the browser application to send another request to the server application for processing.

22. A computer program product capable of configuring a data processor to manage loads, the computer program product comprising program code to cause the data processor to perform the steps of:
receiving by a server a request for service from a browser;
determining a quality of service for the request, the quality of service reflecting an ability of the server to respond to the request based on a type associated with the request; and
providing an appointment cookie to the browser reflecting a time at or after which the server will be available to process the request.

23. A computer program product capable of configuring a data processor to manage loads, the computer program product comprising program code to:
receive by a server a request for service from a client;
determine a quality of service for the request, the quality of service reflecting an ability of the server to respond to the request based on a type associated with the request; and
provide an appointment to the client reflecting a time at or after which the server will be available to process the request.

24. A computer program product of claim 23 wherein said type associated with a request is compared to prior requests of said type.

25. A computer program product, in a system having a client and a server, capable of configuring a data processor to manage loads, the computer program product comprising program code to:
transmit a request for service to a server; and
receive from the server an appointment cookie reflecting a time at which the server will be available to process the request.

26. The computer program product of claim 25, further comprising:
program code to enable display of the appointment cookie.

27. The computer program product of claim 25, further comprising:
program code to retransmit the request to the server at or after the time reflected by the appointment cookie.

28. The computer program product of claim 25, further comprising:
program code to automatically without user intervention re-transmit the request to the server at or after the time reflected by the appointment cookie.

29. A computer program product, in a system having a client and a server, capable of configuring a data processor to manage loads, the computer program product comprising program code to:
transmit a request for service to a server; and
receive from the server an appointment reflecting a time at which the server will be available to process the request.

30. A computer program product, in a system having a client and a server, capable of configuring a data processor to manage loads, the computer program product comprising program code to:
transmit a request for service to a server;
receive from the server an appointment reflecting a time at which the server will be available to process the request; and
resubmit the request to the server application.

31. A computer program product, in a system having a client and a server, capable of configuring a data processor to manage loads, the computer program product comprising program code:
receive a request for service from the client;
determine a quality of service associated with providing the client with a response to the request; and
provide the client with an appointment reflecting a time at which the server will be available to process the request based on a result of the determination.

32. A computer program product, in a system having a client and a server, capable of configuring a data processor to manage loads, the computer program product comprising program code to cause the data processor to perform the steps of:
receive a request for service from the client;
determine a quality of service associated with providing the client with a response to the request; and
provide the client with an appointment cookie reflecting a time at which the server will be available to process the request based on a result of the determination.

33. A computer program product, in a system having a client and a server, capable of configuring a data processor to manage loads, the computer program product comprising program code to:
receive a request for a service to be performed by the process;
determine whether the process is able to perform the requested service subject to a predetermined level of quality; and
create an appointment indicating that the process is not able to perform the requested service subject to a predetermined level of quality and reflecting a time at which it is determined that the process will be able to perform the requested service subject to a predetermined level of quality.

34. The computer program product of claim 33, wherein the predetermined a level of quality represents a time factor.

35. A computer program product, in a system having a client and a server, capable of configuring a data processor to manage service, the computer program product comprising program code to:
receive, from the first computer, a request for service;
determine for the request an estimated quality of service reflecting when the second computer will be able to respond to the request; and
if the estimated quality of service is not satisfactory, return, to the first computer, an appointment,
whereby the second computer will respond to the request for service at or after a time specified by the appointment.

36. A computer program product, in a system having a client and a server, capable of configuring a data processor to manage service, the computer program product comprising program code to cause the data processor to perform the steps of:
transmit, to the second computer, a request for service;
receive an appointment, reflecting an estimated time when the second computer will be able to respond to the request; and
resubmit the request to the second computer on or after the time indicated in the appointment.

37. A system for managing services in a network having a plurality of client devices, each operating a browser application, and a host device operating a server application, the system comprising:
means for receiving, by the server application from the browser applications, requests for services;
means for determining for each request a quality of service reflecting an ability of the server application to respond within a predetermined time based on a type associated with the request; and
means for returning, by the server application to at least one browser application, an appointment reflecting a time for the browser application to send another request to the server application for processing.

38. A system for load management comprising:
means for receiving by a server a request for service from a browser;
means for determining a quality of service for the request, the quality of service reflecting an ability of the server to respond to the request based on a type associated with the request; and
means for providing an appointment cookie to the browser reflecting a time at or after which the server will be available to process the request.

39. A system for load management comprising:
means for receiving by a server a request for service from a client;
means for determining a quality of service for the request, the quality of service reflecting an ability of the server to respond to the request based on a type associated with the request; and
means for providing an appointment to the client reflecting a time at or after which the server will be available to process the request.

40. A system of claim 39 wherein said type associated with a request is compared to prior requests of said type.

41. A system for load management having a client and a server, the system comprising the steps, performed by the client, of:
means for transmitting a request for service to a server; and
means for receiving from the server an appointment cookie reflecting a time at which the server will be available to process the request.

42. The system of claim 41, further comprising:
means for enabling display of the appointment cookie.

43. The system of claim 41 further comprising:
means for re-transmitting the request to the server at or after the time reflected by the appointment cookie.

44. The system of claim 41, further comprising:
means for automatically without user intervention re-transmitting the request to the server at or after the time reflected by the appointment cookie.

45. A system for load management having a client and a server, the system comprising the steps, performed by the client, of:
means for transmitting a request for service to a server; and
means for receiving from the server an appointment reflecting a time at which the server will be available to process the request.

46. A system for load management having a client and a server, the system comprising the steps, performed by the client, of:
means for transmitting a request for service to a server;
means for receiving from the server an appointment reflecting a time at which the server will be available to process the request; and
means for resubmitting the request to the server application.

47. A system for load management having a client and a server, the system comprising the steps, performed by the server, of:
means for receiving a request for service from the client;
means for determining a quality of service associated with providing the client with a response to the request; and
means for providing the client with an appointment reflecting a time at which the server will be available to process the request based on a result of the determination.

48. A system for load management having a client and a server, the system comprising the steps, performed by the server, of:
means for receiving a request for service from the client;
means for determining a quality of service associated with providing the client with a response to the request; and
means for providing the client with an appointment cookie reflecting a time at which the server will be available to process the request based on a result of the determination.

49. A system for load management a process operating in a server computer, comprising:
means for receiving a request for a service to be performed by the process;
means for determining whether the process is able to perform the requested service subject to a predetermined level of quality; and
means for creating an appointment indicating that the process is not able to perform the requested service subject to a predetermined level of quality and reflecting a time at which it is determined that the process will be able to perform the requested service subject to a predetermined level of quality.

50. The system of claim 49, wherein the predetermined level of quality represents a time factor.

51. In a system for managing services comprising a first computer and a second computer, a system for managing service by a second computer, the system comprising:
means for receiving, from the first computer, a request for service;
means for determining for the request an estimated quality of service reflecting when the second computer will be able to respond to the request; and
if the estimated quality of service is not satisfactory, means for returning, to the first computer, an appointment,
whereby the second computer will respond to the request for service at or after a time specified by the appointment.

52. In a system for managing services comprising a first computer and a second computer, a system for managing service by a first computer, the system comprising:
means for transmitting, to the second computer, a request for service;
means for receiving an appointment, reflecting an estimated time when the second computer will be able to respond to the request; and
means for resubmitting the request to the second computer on or after the time indicated in the appointment.
